(19) United States
(12) Patent Application Publication
(10) Pub. No.: US 2002/0071804 A1
(43) Pub. Date: Jun. 13, 2002

(54) Method of producing silicon carbide: high temperature sensor elements

(75) Inventor: Gady Golan, Hod Hasharon (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: SILBID LTD.

(21) Appl. No.: 09/734,553

(22) Filed: Dec. 13, 2000

Related U.S. Application Data
(60) Provisional application No. 60/230,443, filed on Sep. 6, 2000.

(51) Int. Cl. C01B 31/36

(52) U.S. Cl. 423/346

(57) ABSTRACT

A method of producing silicon carbide (SiC) high-temperature sensor elements by mixing a quantity of finely-divided particles of carbon in a binder; shaping, the mixture; applying finely-divided particles of elemental silicon over the shaped mixture; and heating the shaped mixture in a furnace, while subjected to a vacuum, to vaporize and diffuse the silicon and to react the silicon vapor with the carbon in the binder to convert the carbon to silicon carbide. The silicon particles are substantially free of dopants to produce a silicon carbide high-temperature sensor element having a high internal resistance of at least hundreds of Kilohm-cms.

### RELATED APPLICATIONS

The present application is related to Provisional Application No. 60/230,443 filed Sep. 6, 2000, and claims the priority date of that application.

### FIELD AND BACKGROUND OF THE INVENTION

The invention in the present application relates to a novel method of producing silicon carbide (SiC). The method is particularly useful for producing silicon carbide heating and lighting elements, high-temperature sensor elements, and finely-divided particles of silicon carbide, (e.g., for use as abrasives, for hardening surfaces, etc.), but can also be used for producing silicon carbide for many other applications, such as semi-conductor substrates, hard coatings turbine blades, high power switching devices, cosmic radiation protectors, etc. The present application is directed to the production of high-temperature sensor elements of silicon carbide (SiC).

Silicon carbide (SiC), sometimes referred to as carborundum, is a hard, clear, green-tinged or yellow-tinged crystalline compound, which is normally insulating but which becomes conductive when properly heated at a high temperature; for example, when heated to 2000° C., it is as conductive as graphite. This material, therefore, is frequently classified as a semiconductor. It is presently used in a wide variety of applications, including abrasives, heating elements, illuminating elements, high-temperature sensors and semiconductor substrates. Because of its highly unique properties, particularly hardness, heat resistance, semiconductivity, thermal and electrical stability, and corrosion resistance, it is commonly considered as the material of the future.

Silicon carbide is generally manufactured, according to one known method, by heating pure silica sand and carbon in the form of coke in an electrical furnace.

According to another known method, a graphite heating element in a cylinder bar is covered with mixture of carbon powder and quartz and high electrical current is passed through it to create a temperature of up to 3000° C. At this temperature, the quartz (S₁O₂) is broken down to pure silicon, which reacts with the carbon powder and creates the required SiC. At a lower temperature zone, a distance from the heater, the SiC begins crystallizing in the shape of small scales. These scales are ground to form a powder of the required size. This process of SiC powder synthesis which takes place in a vacuum (10⁻³ Torr), requires in the order of 36 hours, as well as high electrical currents. Moreover, it is difficult to obtain a powder of the required grain size with this process.

Approximately 45 years ago a new concept was proposed by Lely for growing, silicon carbide crystals of high quality; and approximately 20 years ago, a seeded sublimation growth technique was developed (sometimes referred to as the “modified Lely Technique”). The latter technique lead to the possibility for true bulk crystal preparation.

However, these techniques are also relatively expensive and time-consuming, such that they impose serious limitations on the industrial potential of this remarkable material. In addition, silicon carbide prepared in accordance with these known techniques generally vary in resistance with temperature, and/or lose power with age, thereby requiring extra controls, special compensations, and/or frequent replacement.

### OBJECTS AND BRIEF SUMMARY OF THE INVENTION

An object of the invention in the present application is to provide a new method of producing silicon carbide high-temperature sensor elements having advantages in one or more of the above respects.

According to a broad aspect of the present invention, there is provided a method of producing silicon carbide (SiC) high-temperature sensor elements comprising: mixing a quantity of finely-divided particles of carbon in a binder; applying finely-divided particles of elemental silicon over the carbon particles in the binder; and heating the silicon particles, and the carbon particles in the binder, while subjected to a vacuum, to vaporize the silicon particles and to revamp the silicon vapor with the carbon particles in the binder to convert the carbon to silicon carbide; the silicon particles being substantially free of dopants to produce a silicon carbide high-temperature sensor element having a high internal resistance of at least hundreds of kilohms-cms.

By elemental silicon is meant the silicon element, as distinguished from the silicon dioxide compound (e.g., sand, glass, quartz). Preferably, the silicon is relatively pure except for possible traces of impurities or dopants, such as present in silicon semiconductor substrates. In fact particularly good results were obtained, as described below, when the silicon used was the wastage in the manufacture of silicon semiconductor substrates.

Preferably, the carbon is either lignite carbon or anthracite carbon ground to a fine talc or power form.

During this heating process, the silicon vaporizes, diffuses into the carbon, and converts it to silicon carbide (SiC). Silicon carbide when substantially free of dopants has a yellow-tinged color, and therefore the formation of such a color during the above-described heating process indicates that the resulting product is indeed silicon carbide.

Since the novel method utilizes elemental silicon, rather than S₁O₂ (as in sand, glass or quartz), it does not require the high temperatures (e.g., the order of 3000° C.), or the long heating time (e.g., the order of 36 hours) required on the prior art process as described above.

The method may be used in a wide variety of applications for producing various shaped articles of silicon carbide. The present application relates particularly to the production of silicon carbide, high-temperature sensor elements.

In the preferred embodiments of the invention described below, the quantity of silicon is in excess of the quantity of carbon by weight to assure relatively complete conversion of the carbon to silicon carbide, with the excess silicon being removed by removing the silicon vapors during the diffusion process to prevent or minimize condensation of the silicon vapor on the outer surface of the silicon carbide.

Where high-temperature sensors are to be produced, the initial composition preferably includes at least 10% more silicon than carbon, with the silicon being relatively free of dopants; and the heating is preferably effected at a vacuum of higher than 10⁻⁴ Torr and at a temperature of about 1700-1800° C. in order to assure a Si:C ratio of 50:50 and to remove the extra silicon vapors. This technique produces high-temperature sensors having relatively high internal resistance, in the order of hundreds of Kilohm-cm, and a yellow-tinged color.

In some described preferred embodiments, the mixture is prepared by mixing the finely-divided particles of carbon in a water solution of sucrose, and in other described preferred embodiments, the mixture is prepared by mixing the finely-divided particles of carbon in polyvinyl acetate. In both cases, the carbon mixture is prebaked at about 500° C. in order to harden the sample. It will be appreciated, however, that other binders may be used.

According to further features in the described preferred embodiments, the carbon and silicon are both contained in a graphite crucible when heated within the furnace. The crucible is at least partly open at its upper end to the interior of the furnace to permit excess silicon vapors to escape to the interior of the furnace, and thereby to prevent or minimize condensation of silicon vapors on the outer surface of the silicon carbide.

Further features and advantages of the invention will be apparent from the description below.

### BRIEF DESCRIPTION OF THE DRAWINGS

The invention is herein described, by way of example only, with reference to the accompanying drawing diagrammatically illustrating one form of apparatus for use in preparing shaped silicon carbide high-temperature sensor elements in accordance with the method of the present invention.

### DESCRIPTION OF PREFERRED EMBODIMENTS

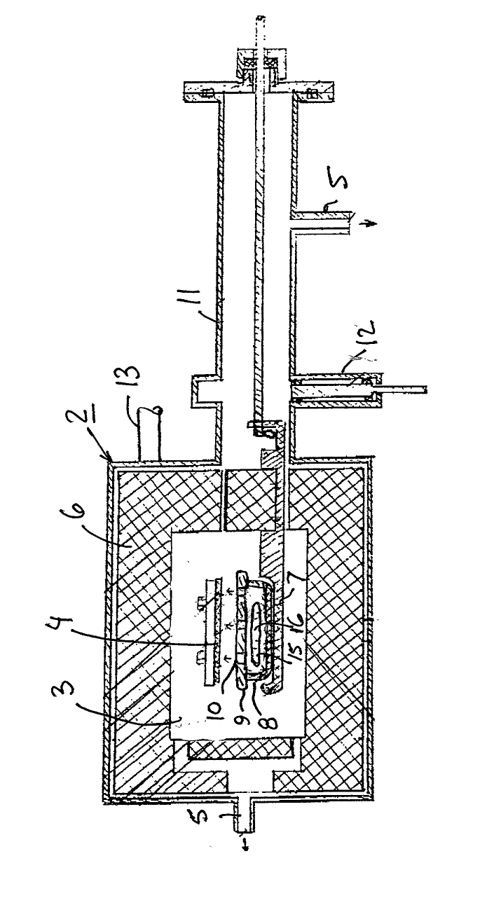

FIG. 1 illustrates one form of apparatus for use in producing shaped articles of SiC, particularly high-temperature sensor elements in accordance with the present invention.

The apparatus illustrated in FIG. 1 includes a furnace, generally designated 2, whose interior 3 is heated by a plurality of planar electrical heating elements 4. A pump (not shown) communicates with the interior 3 of the furnace via gas outlets 5, for producing a vacuum therein. The interior of the furnace is lined with graphite walls 6 for heat isolation.

Disposed within the interior 3 of the furnace is a table 7 for supporting a crucible 8 to receive the work materials which, when subjected to heat and vacuum as described below, produce articles of silicon carbide. Crucible 8 is of hardened graphite. Its upper end is covered by a graphite lid 9 formed with openings 10 to provide communication between the interior of the crucible and the interior 3 of the furnace 2, as will be described more particularly below.

The work materials to be treated are introduced into the furnace via an insertion pipe 11. Pipe 11 includes the main gas outlet 5 connected to the vacuum pump (not shown), and also a vacuum valve 12. The furnace 2 further includes an electric feed-through 13 for supplying the electrical current to the heating elements.

Such electrical furnaces are well known, and therefore further details of its structure and the manner of operating it are not set forth herein.

In the examples to be described below, the shaped workpiece of silicon carbide to be produced is a rod, wire or electrode, to be used in the manufacture of high-temperature sensor elements. FIG. 1 illustrates the workpiece, therein generally designated 15, of the desired shape disposed within the crucible 8. This workpiece is prepared from a mixture of carbon in the form of finely-divided particles mixed in a binder to produce a doughy mixture which can be shaped as desired, in this case according to a rod, wire or electrode. Preferably, the carbon is either lignite carbon or anthracite carbon ground to a fine talc or power form. The carbon-binder mixture is pre-baked in order to harden the workpiece.

Finely-divided particles of relatively-pure elemental silicon 16 (as distinguished from silicon dioxide, as in, e.g., sand or quartz) are applied over the complete outer surface of the shaped workpiece 15 before the latter is placed in the crucible 8. The crucible is then covered by the lid 9 and placed on table 7 in the interior of the furnace.

The interior of the furnace, with the crucible 8 and workpiece 15 therein, is subjected to a vacuum via gas outlets 5, and is heated by electrical heating elements 4. This heating of the interior of the furnace 3 is at a sufficiently high temperature, and for a sufficiently long period of time, to vaporize the silicon and to cause its vapors to diffuse and to react with the carbon to produce silicon carbide. Thus, the heating may be continued until the workpiece 15 exhibits a yellow-tinged color, thereby indicating that the silicon particles 16 applied over the carbon-containing body 15 have converted the carbon to silicon carbide.

Crucible lid 9 is provided with the openings 10 to permit the silicon vapors to escape during the heating process into the interior 3 of the furnace. This prevents or reduces the condensation and deposition of silicon on the outer surface of the workpiece 15. If such a deposition is produced, it can be removed by a suitable silicon etchants.

Following are several examples for producing silicon carbide high-temperature sensor elements:

### EXAMPLE 1

In this example, the carbon particles used for making the shaped workpiece 15 are finely-divided particles of charcoal having a particle size of 50-250 microns; and the silicon particles 16 applied over the shaped workpiece 15 are finely-divided particles of the waste of silicon wafers, both the mono-crystalline and the poly-crystalline type, resulting from the production of semiconductor devices, also ground to a fine particle size. The silicon component, however, is relatively free of dopants and impurities in order to obtain a high internal resistance in the produced sensor element. In addition, the quantity of the silicon should exceed by at least 10% the quantity of the carbon by weight, in order to provide an excess of silicon vapor during the heating process, as described more particularly below.

The carbon particles are mixed in a binder of white sugar (sucrose) dissolved in soft water (one kilogram of white sugar with a few liters of water), which water is subsequently evaporated. The carbon particles are homogeneously mixed in the sugar solution by means of a blender, pre-baked at about 500° C. to a doughy consistency, and then shaped to the desired configuration (e.g., a rod).

The shaped workpiece 15 (consisting of carbon particles in the binder) is covered by finely-divided particles of the silicon powder 16, and is then placed within the crucible 8 and covered by the lid 8. The interior of the oven 3 is evacuated to a pressure higher than 10⁻⁴ Torr and heated to a temperature of 1700° C.-1800° C. for a period of 30 minutes. During this period, the silicon powder 16 vaporizes and diffuses into the carbon of the workpiece 15, converting it to silicon carbide. This is manifested by a yellow-tinged color.

Upon completion of the heating process, the workpiece is retained in the oven for a period of approximately 3-hours after the heating elements have been de-energized, to permit a gradual cooling of the workpiece in an annealing. The workpiece was then removed from the oven.

Since the vapor pressure of silicon is higher than that of carbon, the relatively high heating temperature (1700° C.-1800° C.), and the relatively high vacuum, (higher than 10⁻⁴ Torr) cause the excess silicon to evaporate until the required equal amounts of 50/50 of silicon:carbon is obtained. In addition, the use of silicon free of dopants and impurities in the initial material produces a silicon carbide body of high internal resistance, in the order of hundreds of Kilohm-cms and higher.

### EXAMPLE 2

This example is the same as Example 1, except that the finely-divided particles of carbon are mixed in a binder of polyvinyl acetate, in an amount of 0.5 kg of polyvinyl acetate to one kg. of carbon, instead of the sugar solution. The process is otherwise the same as in Example 1.

### EXAMPLE 3

This example is also the same as Example 1, except that the sample is heated to an even higher temperature of 2200° C. in the furnace for a period of about 15 minutes, rather than a temperature of 1700° C.-1800° C. for 30 minutes as in Example 1. The remainder of the procedure is otherwise the same as in Example 1.

Silicon carbide high-temperature sensor elements can thus be made according to the foregoing examples to have some or all of the following advantages: stable thermal and electrical performance over time and numerous operations; vibration and shock proof; operable in an open air environment without oxidizing and without releasing poisonous gasses; capable of operation in corrosive and aggressive conditions without degradation in performance; lower manufacturing cost compared to conventional SiC elements; easily structured in various sizes and shapes; and extremely radiation hard and therefore protective against nuclear radiation;

While the invention has been described with respect to several preferred examples, it will be appreciated that these are set forth merely for purposes of illustrating the invention, and that many other variations, modifications and applications of the invention may be made.

What is claimed is:

1. A method of producing silicon carbide (SiC) high-temperature sensor elements, comprising:
mixing a quantity of finely-divided particles of carbon in a binder;
applying finely-divided particles of elemental silicon over the carbon particles in the binder;
and heating the silicon and the carbon in the binder, in a furnace subjected to a vacuum, to vaporize and diffuse the silicon and to react the silicon vapor with the carbon in the binder to convert the carbon to silicon carbide;
said silicon particles being substantially free of dopants to produce a silicon carbide high-temperature sensor element having a high internal resistance of at least hundreds of kilohm-cms.

2. The method according to claim 1, wherein said heating is at a temperature of at least 1700° C. for a period of time until the heated product assumes a yellow-tinge color.

3. The method according to claim 2, wherein said silicon is present, before heating, in an amount which is in excess of the carbon by weight.

4. The method according to claim 3, wherein said heating temperature and vacuum are sufficiently high to vaporize the excess silicon and to produce a 50:50 ratio of the silicon and carbon in the resultant product.

5. The method according to claim 3, wherein said silicon is present, before heating, in an amount which is in excess of the carbon by at least 10% by weight.

6. The method according to claim 3, wherein said heating is effected while the heated product is under a vacuum of at least 10⁻⁴ Torr.

7. The method according to claim 1, wherein the finely-divided particles of carbon are mixed in a water solution of sucrose and the mixture is pre-baked to harden it, before the finely-divided particles of silicon are applied thereover.

8. The method according to claim 1, wherein said carbon particles are mixed in polyvinyl acetate.

9. The method according to claim 1, wherein the silicon particles, and the carbon particles in the binder, are contained in a graphite crucible when heated within the furnace.

10. The method according to claim 9, wherein said crucible is at least partly open at its upper end to the interior of the furnace to permit excess silicon vapors to escape to the interior of the furnace, and thereby to suppress deposition of silicon on the outer surface of the resulting product.

11. The method according to claim 1, wherein the heated product, after being heated, is gradually cooled to room temperature over a period of time substantially longer than the heating time before being removed from the furnace.

12. The method according to claim 1, wherein the binder containing the finely-divided particles of carbon is shaped before the finely-divided particles of silicon are applied over its outer surface.

13. The high-temperature sensor element produced according to the method of claim 1.
